(19) United States
(12) Patent Application Publication
(10) Pub. No.: US 2006/0053761 A1
(43) Pub. Date: Mar. 16, 2006

(54) Floating attachment linkage

(75) Inventors: Christopher W. Lougheed, Bismarck, ND (US); Corwin E. Waswick, Gwinner, ND (US); Verne C. Watts, Lisbon, ND (US); Aaron R. Haaland, Bismarck, ND (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Clark Equipment Company, Woodcliff Lake, NJ (US)

(21) Appl. No.: 10/938,129

(22) Filed: Sep. 10, 2004

(51) Int. Cl. A01D 34/64

(52) U.S. Cl. 56/15.8

(57) ABSTRACT

A mower comprising a mower housing with an open bottom for mowing underneath the housing. A mower blade is positioned with the housing and is driven by a motor mounted to the housing. A linkage assembly attaches a prime mover to the housing and supports the mower relative to the prime mover wherein the linkage assembly provides vertical and rotational movement of the housing about an axis along a path of travel of the mower.

### BACKGROUND OF THE INVENTION

The present invention relates to linkage assembly for mounting an attachment to a prime mover. In particular, the linkage assembly enables a pitch of the attachment to be initially set and maintained during operation while allowing for vertical movement and rotational movement of the attachment about an axis along a forward path of travel while restricting lateral movement of the attachment.

Attachments, such as mowers, that are mounted to prime movers, such as skid steer loaders, are known in the art. However, the linkage that attaches the attachment to the prime mover typically does not allow the pitch of the attachment to be set prior to use and maintained during use even as the attachment travels over uneven terrain. Additionally, linkages that mount attachments to prime movers in the prior art do not allow the attachment to float over the terrain by providing for vertical and rotational movement of the attachment. Especially in the case of a mower, the inability of the mower to float about the terrain causes an uneven cutting which may provide a unsatisfactory result.

### SUMMARY OF THE INVENTION

The present invention includes a mower having a housing with an open bottom for mowing underneath the housing. A mower blade or blades are positioned within the housing and is driven by a motor mounted to the housing. A linkage assembly connects a prime mover to the mower housing where the prime mover moves the housing. The linkage assembly allows the housing to vertically move and rotationally move about an axis along a path of travel while limiting the lateral movement of the mower housing.

### BRIEF DESCRIPTION OF THE DRAWINGS

FIG. 1 is a perspective view of a linkage assembly mounting a mower to a prime mover;

FIG. 2 is a right side view of the linkage assembly of the present invention;

FIG. 3 is a left side view of the linkage assembly of the present invention;

FIG. 4 is a sectional view of a ball joint of the present invention along section line 4-4 in FIG. 2;

FIG. 5 is a side view of a shut off valve of the present invention; and

FIG. 6 is a front view of the linkage assembly of the present invention allowing an attachment to tilt.

### DETAILED DESCRIPTION OF THE PREFERRED EMBODIMENTS

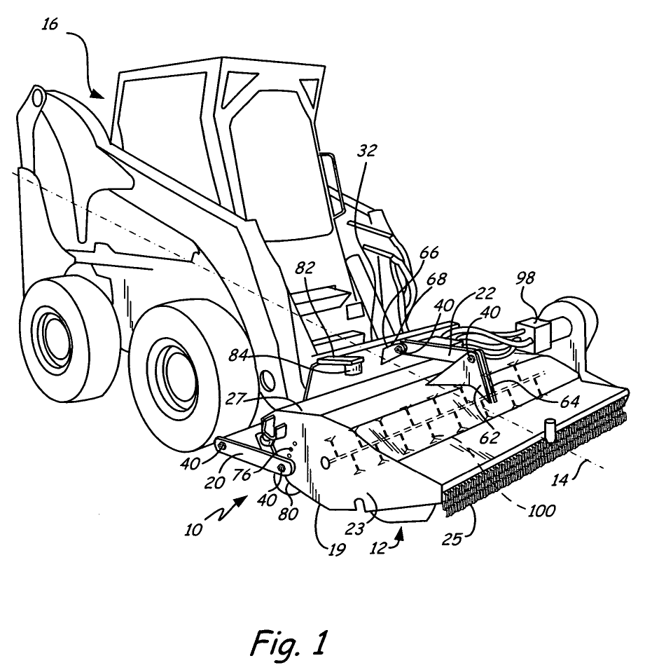

A linkage assembly of the present invention is generally illustrated at 10 in FIG. 1. The linkage assembly 10 attaches a flail mower 12 to a prime mover 16, such as a loader.

The linkage assembly 10 allows the flail mower 12 to move vertically and rotate about an axis 14 of movement along a forward path of travel while limiting the lateral movement of the flail mower 12 with respect to the loader 16. The linkage assembly 10 can also be used to mount other attachments besides a flail mower to the loader 16.

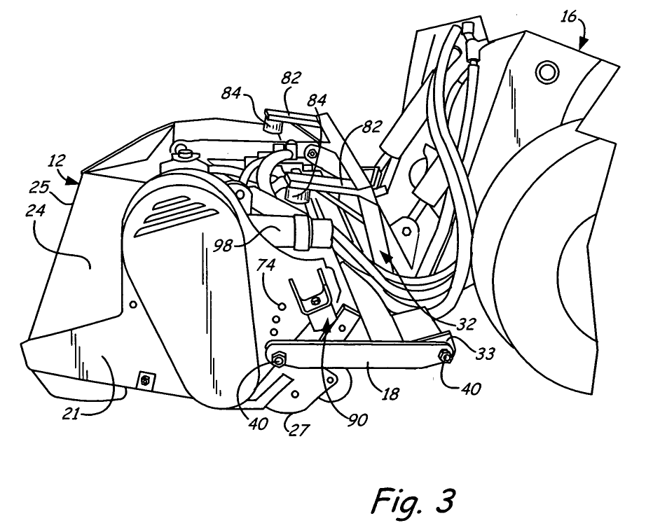

Referring to FIGS. 1-3, the linkage assembly 10 preferably includes three linkages generally parallelly aligned along the axis 14 of the forward path of travel. A left linkage 18 is attached to a left side panel 21 of flail mower housing 24 and proximate a lower left corner 33 of an attachment plate 32 that is mounted to the loader 16. A right linkage 20 is attached to a right side panel 23 of the flail mower housing 24 and also proximate a lower right corner 31 of the attachment plate 32. A top linkage 22 is attached proximate a top end 30 of the flail mower housing 24 with a mower mounting bracket 62 and also proximate a top end 38 of the attachment plate 32 with an attachment plate mounting bracket 66.

Each of the linkages 18,20,22 is preferably a rigid member and are approximately the same length. Each of the linkages 18,20,22 also have ball joints 40 proximate each end for attaching each linkage 18,20,22 to the flail mower 12 and to the prime mover 16. Although a linkage assembly 10 having three linkages is preferred, a linkage assembly having four or more linkages is also within the scope of the present invention.

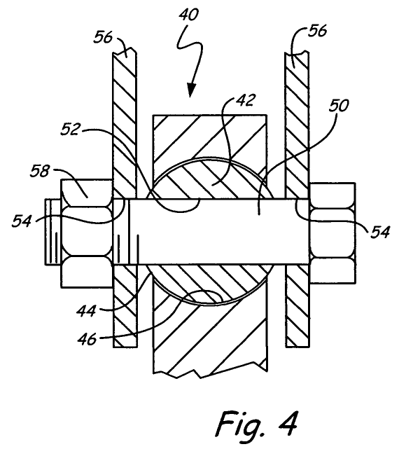

Each ball joint 40 in the left linkage 18, the right linkage 20, and the top linkage 22 are similarly constructed and the components of the ball joint 40 are given the same reference characters. Referring to FIG. 4, each ball joint 40 includes a ball 42 that is rotatably captivated with a through bore 44 in the linkage 18,20,22 defined by an convex arcuate surface 46. The ball 42 has a width similar to a width of the linkage 18,20,22. The ball 42 is retained to either the attachment 12 or the prime mover 16 with a bolt 50 inserted through a through bore 52 in the ball 42 and also through aligned apertures 54 in a mounting bracket 56. The bolt 50 is threadably retained to the mounting bracket 56 with a threaded engagement with a nut 58. The mounting bracket 56 may also include only one plate to which the ball joint is attached.

Although a generally uniform radius ball 42 is preferred, a spheroidal member is also within the scope of the present invention. What is meant by spheroidal is objects having portions of the outer surface which are arcuate although the portion of the outer surface need not be defined by a consistent radial distance from a center of the member such as ellipsoids.

Referring to FIGS. 1-3, the top linkage 22 is mounted to the top mower mounting bracket 62 that is fixedly secured to the flail mower housing 24 proximate the end 30. The top mounting bracket 62 includes parallel vertical plates 64 that have aligned apertures 54 which are aligned with the through bore 52 in the ball 42. The bolt 50 is positioned through the aligned through bore 52 and the apertures 54 and secured therein with the nut 58 thereby mounting one end of the top linkage 22 to the flail mower housing 24.

The other end of the top linkage 22 is mounted to the attachment plate mounting bracket 66 fixedly attached proximate the top end 38 of the attachment plate 32. The top linkage 22 is positioned between two parallel vertical plates 68 having aligned apertures 54 and retained to the attachment plate mounting bracket 66 with the bolt 50 positioned through the aligned apertures 54 in the plates 68 and the through bore 52 in the ball 42.

The left and right linkages 18,20 are adjustably attached to the left and right side panels 21,23, respectively, by positioning the bolt 50 of the ball joint 40 into one of the plurality of apertures 74,76 in left and right side panels 21,23, respectively. The apertures 74,76 are in a generally arcuate alignment within the side panels 21,23 such that adjusting the position of the left and right linkages 18,20 on the left and right side panels 21,23 of the mower housing 24 adjusts a pitch of the flail mower 12 relative to the attachment plate 32. By pitch is meant the height of a front end 25 of the housing 24 relative to a back end 27 of the housing 24 at which the attachment is operated. The plurality of arcuate apertures 74,76 allows the pitch of the housing 24 to be adjusted from generally parallel to ground level to a raised pitch that raises the front end 25 of the housing 24 such that the flail mower 12 better accepts and cuts brush and other tall vegetation.

With the mower housing 24 at the selected pitch, the mower housing 24 is moveable in three axes of movement. However, the lateral movement of the mower housing 24 relative to the prime mover 16 is limited by the left and right linkages 18,20 contacting the mower housing 24.

The left linkage 18 and the right linkage 30 are mounted to both the attachment plate 32 and the flail mower housing 24 to limit lateral movement of the flail mower 12 relative to the loader 16 and also to maintain a parallel alignment of the left and right linkages 18,20, respectively. The left and right linkages 18,20, while each allowing lateral movement of the flail mower housing 24 away from the attachment plate 32, together limit the lateral movement of the flail mower housing 24 relative to the loader 16. When the mower housing 24 begins to move laterally left, the left linkage 18 contacts the mower housing 24 thereby limiting lateral movement in a left direction. Similarly, as the flail mower housing 24 begins to move in a right direction, the right linkage 20 contacts the mower housing 24 thereby limiting movement in a right lateral direction. Therefore, the cooperation of the left and right linkages 18,20 prevents lateral movement of the mower 12 relative to the attachment plate 32 and the prime mover 16.

A height of the flail mower 12 is adjusted with the prime mover 16 by raising or lowering the attachment plate 32 which also raises and lowers the flail mower housing 24. The housing 24 is lowered until a roller 80 attached proximate a bottom edge 19 of the mower housing 24 contacts a ground surface. Although a roller is illustrated, other ground contacting mechanisms are also within the scope of the present invention including, but not limited to, a skid plate.

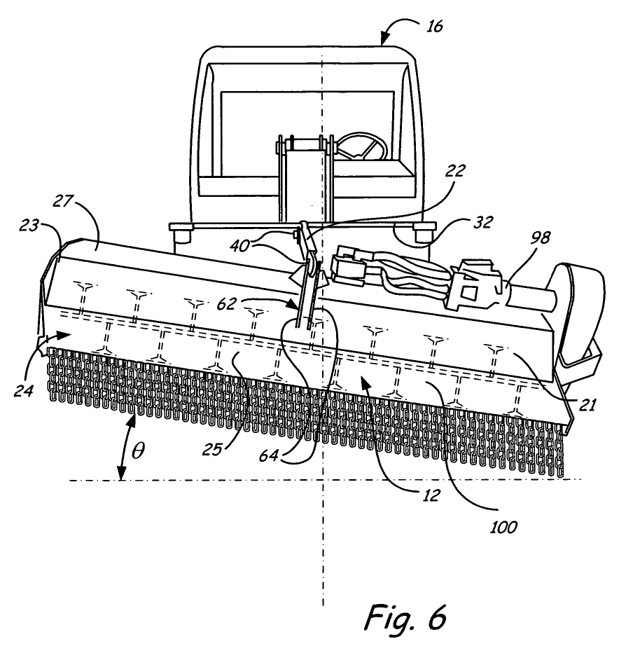

Referring to FIG. 6, with the roller 80 engaging the ground, the mower 12 is moved along a path of travel, the left linkage 18, right linkage 20 and top linkage 22 allow the mower 12 to float on the ground surface whether even or uneven. As the ground surface becomes uneven, the ball joints 40 in the linkages 18,20,22 allow the mower housing 24 to rotate about the axis 14 of travel and follow the contour of the ground as indicated by the angle θ. Rotation about the axis 14 along the path of travel allows one side of the mower housing 24 to raise or conversely lower while the other side remains at the same vertical position or lowers to follow the contour of the ground.

Additionally, the mower housing 24 can adjust vertically to follow the contour of the ground. An upper vertical limit is reached when the mower housing 24 engages arms 82 attached to the attachment plate 32 and extending over the housing 24. Preferably, the arms 82 have pads 84 that contact the mower housing 24 and cushion the impact between the mower housing 24 and the arms 82 when raised by the terrain. When the flail mower 12 is in operation, the floating linkage assembly 10 preferably allows the mower housing 24 to vertically travel about 12 inches.

Additionally, the linkages 18,20,22 are also designed to limit the fore and aft movement of the mower housing 24. Because the linkages 18,20,22 are of a rigid construction that does not readily expand or contract, the fore and aft movement is limited to between preferably about zero and four inches.

The mower 12 is raised by raising the attachment plate 32 with the prime mover 16. As the attachment plate 32 is raised, the left, right and middle linkages 18,20,22 begin to pivot about the ball joints 40. The pivoting left and right linkages 18,20 contact left and right stops 90,92 extending from the mower housing 24. The contact of the left and right stops 90,92 with the left and right linkages 18,20, respectively, prevents further pivotal movement of the left and right linkages 18,20 and causes the mower 12 to raise as the attachment plate 32 raises. Preferably, the stops 90,92 are constructed of a compressive material such as rubber or a compression spring to limit damage caused by the impact of the left and right linkages 18,20 and the left and right stops 90,92.

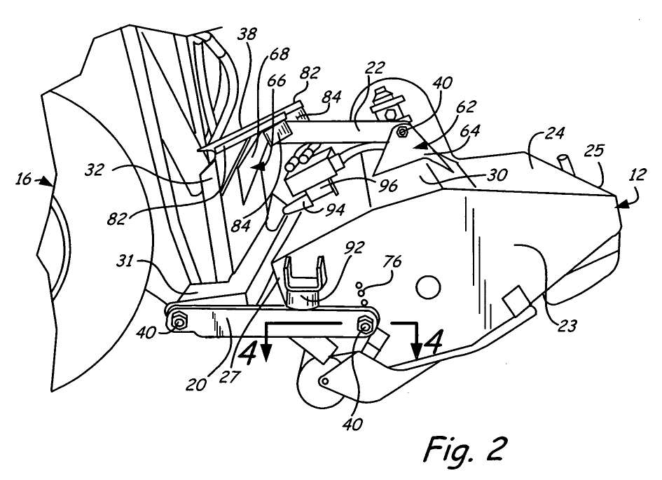

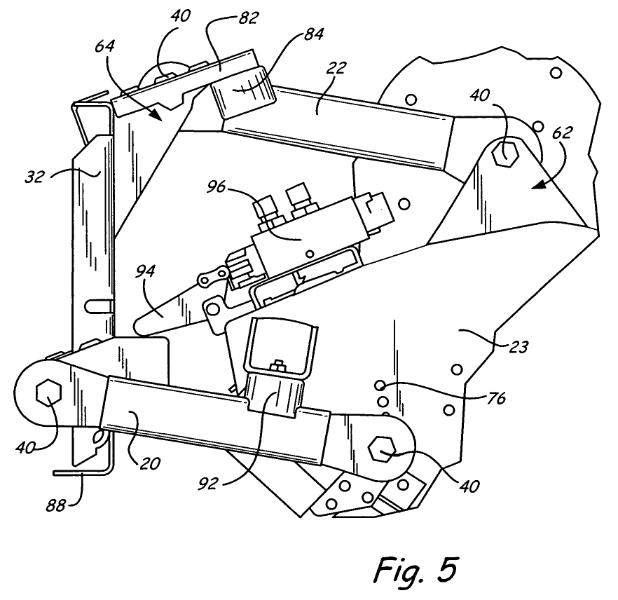

Referring to FIGS. 2 and 5, as the attachment plate 32 is vertically raised, a cam member 94 that is pivotally attached to a shut off valve 96 contacts the attachment plate 32 and begins to exert a force upon the shut off valve 96. When the attachment plate 32 is raised to a relative height to the mower housing 24, the cam member 94 exerts a sufficient force upon the shut off valve 96 to shut off hydraulic power to a motor 98 driving flail blades 100. The shut off valve 96 prevents the flail mower 12 from running at a predetermined height which could be dangerous to the operator or bystanders. Although a shut off valve 96 for a hydraulic system is preferred other actuator mechanisms and different powered systems such as a pneumatic system or an electric system are within the scope of the present invention.

Although the present invention has been described with reference to preferred embodiments, workers skilled in the art will recognize that changes may be made in form and detail without departing from the spirit and scope of the invention.

What is claimed is:

1. A mower comprising:
a mower housing with an open bottom for mowing underneath the housing;
a mower blade positioned within the housing;
a motor mounted to the housing for driving the blade;
a prime mover for moving the housing; and
a linkage assembly for supporting the mower housing relative to the prime mover wherein the linkage assembly provides for vertical movement of the mower housing and rotational movement of the mower housing about an axis along a path of travel of the mower.

2. The mower of claim 1 and wherein the linkage assembly engages a plurality of vertical surfaces to limit lateral movement of the mower in relationship to the axis along the path of travel of the mower.

3. The mower of claim 1 and wherein the linkage comprises:
a left linkage coupled to both the mower housing proximate a left side thereof and the prime mover proximate a left side thereof with ball joints;
a right linkage coupled to both the mower housing proximate a right side thereof and the prime mover proximate the right side thereof with ball joints; and
a middle linkage coupled to the mower housing proximate the axis of travel and the prime mover proximate the axis of travel with ball joints wherein the left linkage, the right linkage and the middle linkage are positioned generally parallel to the axis of travel and wherein the ball joints allows the left linkage, the right linkage and the middle linkage to move in three directions of movement.

4. The mower of claim 3 and wherein each ball joint comprises:
a spheroidal member rotatably captivated within the linkage and having a through bore; and
a shaft positioned through the through bore and supported by a mounting bracket such that the linkage rotates about the spheroidal member in the planes of movement.

5. The mower of claim 3 and further comprising:
a left stop positioned on the mower housing; and
a right stop positioned on the mower housing and wherein the left and right stops engage the left and right linkages as the prime mover lifts the housing to prevent pivotal movement of the linkages such that the prime mover lifts the housing.

6. The mower of claim 3 and wherein the mower housing comprises left and right side members both having a plurality of apertures arcuately positioned therein and wherein the left linkage and the right linkage are secured into a selected aperture to fix a pitch of the mower housing.

7. The mower of claim 1 and further comprising an arm extending from the prime mover over an upper surface of the mower housing and wherein the arm limits an upward movement of the mower housing engaged with the ground surface.

8. The mower of claim 1 and further comprising a shutoff mechanism connecting to the mower housing and engaging the prime mover and wherein when the mower housing raised to a selected height, the shut off mechanism removes power from the motor.

9. The mower of claim 1 and further comprising a ground engaging member that contacts the ground when the mower operates.

10. The mower of claim 9 and wherein the ground engaging member comprises a roller.

11. A linkage assembly for connecting an attachment to a prime mover comprising:
a left rigid linkage having a proximal end connected to the attachment proximate a left side thereof and a distal end connected to the prime mover proximate a left side thereof within one of a plurality of left securing locations;
a right rigid linkage having a proximal end connected to the attachment proximate a right side thereof and a distal end connected to the prime mover proximate a right side thereof within one of a plurality of right securing locations and wherein the left rigid linkage and the right rigid linkage are approximately the same size and positioned approximately parallel to each other; and
a top rigid linkage having a proximal end connected to the attachment proximate a top surface thereof and between the left and right rigid linkages and a distal end connected to the prime mover above the connection of the left and right rigid linkages and wherein the left and right rigid linkages are each secured within one of the plurality of securing locations to adjust and fix a pitch of the attachment.

12. The linkage assembly of claim 11 and wherein the left, right and top rigid linkages allow for vertical motion of the attachment and rotation about an axis along a direction of travel and restricts lateral movement of the attachment with respect to the prime mover.

13. The linkage of claim 11 and wherein each of the left linkage, the right linkage and the top linkage connects to the attachment and the prime mover each with a ball joint.

14. The linkage of claim 13 and wherein each ball joint comprises:
a spheroidal member rotatably captivated within the linkage and having a through bore; and
a shaft positioned through the through bore and engaging a mounting bracket such that the linkage rotates about the spheroidal member.

15. The linkage of claim 11 and further comprising:
a left stop positioned on the mower and engaging the left linkage; and
a right stop positioned on the mower and engaging the right linkage and wherein the left and right stops engage the left and right linkages and prevent the linkages from pivoting such that as the prime mover raises the attachment raises.

16. A mechanism for disabling an attachment having a power source and coupled to a prime mover comprising:
an actuator mechanism mounted to the attachment; and
a camming member coupled to the actuator mechanism and contacting the prime mover such that as the attachment is lifted the prime mover exerts a force upon and rotates the camming member and wherein the camming member exerts a force upon the actuator mechanism at a selected height of the attachment such that the power source to the attachment is interrupted.

17. The mechanism of claim 16 and wherein the actuator mechanism comprises a hydraulic valve.

18. The mechanism of claim 16 and wherein the camming member comprises a plate having a camming surface that engages the actuator mechanism.
